(19) United States
(12) Patent Application Publication
(10) Pub. No.: US 2021/0019409 A1
(43) Pub. Date: Jan. 21, 2021

(54) SYSTEM AND METHOD FOR IDENTIFYING SYSTEM FILES TO BE CHECKED FOR MALWARE USING A REMOTE SERVICE

(71) Applicant: AO Kaspersky Lab, Moscow (RU)

(72) Inventors: Yury G Parshin, Moscow (RU); Dmitry V. Vorontsov, Moscow (RU); Yury V. Spravtsev, Moscow (RU); Andrey L. Kirzhemanov, Moscow (RU)

(21) Appl. No.: 16/793,461

(22) Filed: Feb. 18, 2020

(30) Foreign Application Priority Data
Jul. 17, 2019 (RU) 2019122438

(51) Int. Cl. G06F 21/56; G06F 21/53

(52) U.S. Cl. CPC G06F 21/566; G06F 21/53

(57) ABSTRACT

Disclosed herein are systems and methods for identifying system files to be checked for malware using a remote service. In one aspect, an exemplary method comprises, using a security application, selecting at least one system file and identifying at least one attribute of the selected system file, obtaining attributes of the selected system file from a repository at which one or more of: system files of an operating system, and attributes of the system files, are stored, comparing the attributes obtained from the repository against the identified at least one attribute, when the identified at least one attribute does not match the attributes obtained from the repository, sending the selected at least one system file to a remote service for determining whether the at least one system file contains malware, and receiving a response from the remote service indicating whether the selected at least one system file contains malware.

### CROSS REFERENCE TO RELATED APPLICATIONS

The present application claims priority to Russian Patent Application No. 2019122438, filed on Jul. 17, 2019, the entire content of which is incorporated herein by reference.

### FIELD OF TECHNOLOGY

The present disclosure relates to the field of data security, more specifically, to systems and methods for identifying system files to be checked for malware using a remote service, e.g., a cloud service or a service provided by a remote server.

### BACKGROUND

At present, the amount of malicious software (such as computer viruses, Trojan horses, Internet worms) is on the rise. The malicious software is typically designed to cause harm to both the data of users and to the users of electronic devices infected with malicious software. For example, the harm may be caused by: damaging or removing user files, using resources of computing device of the user for “mining” of crypto currencies, theft of confidential user data (correspondence, pictures, logins, passwords, bank card data), and other similar actions. Moreover, the malicious software is constantly changing. For instance, as users update the security of their devices and install security applications, the creators of the malicious software resort to new method of attack. One approach to prevent such attacks by malicious software is obfuscation of the malicious code. For example, the obfuscation may include placing the original text or executable program code in a form preserving its functionality while resisting analysis, and understanding how the algorithms of the malicious software operate (e.g., to determine whether or not the malicious software makes modifications during compilation). Another approach is to use mechanisms for counteracting emulation (for example, the malicious software may be equipped with functions for recognizing that it is being run in a virtual environment, and may not manifest its harmful activity when it is being run in the virtual environment).

However, the approaches describes above may not be effective if the creators of the malicious software include features that enable it to avoid detection for some time. For example, malicious software often does not manifest its harmful activity all at once, but instead performs many API function calls (of the order of millions of calls), enormous cycles (of the order of billions of iterations), stops working for a certain time right after being launched (for example, for 1 hour, by using the “Sleep( )” function). The computing devices of users have high performance and employ multicore processors (and are in fact multiprocessor systems). Therefore, the user cannot see or attach significance to the workload of one of the cores. Moreover, the user usually uses the device for more than one hour after turn-on. Therefore, there is no need for malicious software, if launched, to manifest its activity all at once.

In addition, the malicious software may be intended for launching targeted attacks (advanced persistent threat, APT). Such targeted attacks are carried out on organizations and companies as a whole. Targeted attacks are usually conducted against the infrastructure of the organization/company by exploiting program vulnerabilities and applying methods of “social engineering”. Cases are known where such attacks have been carried out using several simple applications, wherein the individual applications did not manifest any malicious activity. However, when executed jointly after gaining access to the infrastructure of the attacked organization/company, the combination of the several simple applications is able to inflict harm.

It should be noted that security applications use various methods to identify malicious software, such as methods based on signature and/or heuristic analysis. During the analysis, when no harmfulness of a file is determined, the file may be sent, by the security application, to the virtual machine for analysis of its behavior. For example, when the file does not have a digital certificate from a trusted software manufacturer, it may be send to the virtual machine for behavior analysis. Then, the file sent to the virtual machine is executed in the virtual machine, actions and events occurring as a result of various function calls during the execution of the file are intercepted, information about the intercepted events and actions is saved in a log, and the content of the log is subsequently analyzed by the security application or by an expert in information security in order to identify the malicious software. Often such virtual machines are known as a “sandbox”. The hypervisors under whose control such virtual machines operate contain mechanisms for the interception of functions called up by the applications being executed in the virtual machines. In one aspect, the identification of the malicious software includes using neural networks.

All of the approaches described above have shortcomings in terms of identifying malicious files on a local computing device of a user. For example, the files may (for example, in the case of an APT attack) be signed by a trusted certificate and perform actions which cannot be viewed with certainty (definitively) as being malicious. For example, the opening of a “.DOC” file, closing without altering it, sending a data packet or an email appear to be normal actions. These actions are viewed as being safe from the standpoint of a security application (there are many programs which are able to open text files and send messages and/or email). However, the opened filed may contain confidential data. Thus, as a result of the execution of such files a theft of confidential data from the opened file is possible. Often, such malicious files alter or substitute their system files for the operating system (or applications) to carry out malicious activity. The approaches described above are complex and require considerable resources, e.g., resources of the computing device and time—thereby inconveniencing the user.

Thus, there is a need for a more optimal way for identifying system files to be checked for malware using a remote service.

### SUMMARY

Aspects of the disclosure relate to data security, more specifically to systems and methods for identifying system files to be checked for malware using a remote service.

In one exemplary aspect, a method for identifying system files to be checked for malware using a remote service is implemented in a computer comprising a hardware processor, the method comprising: using a security application, selecting at least one system file and identifying at least one attribute of the selected at least one system file, obtaining attributes of the selected at least one system file from a repository at which one or more of: system files of an operating system, and attributes of the system files, are stored, comparing the attributes of the selected at least one system file obtained from the repository against the identified at least one attribute of the selected at least one system file, when the identified at least one attribute of the selected at least one system file does not match the attributes obtained from the repository, sending the selected at least one system file to a remote service for determining whether or not the at least one system file contains malware, and receiving a response from the remote service indicating whether or not the selected at least one system file contains malware.

According to one aspect of the disclosure, a system is provided for identifying system files to be checked for malware using a remote service, the system comprising a hardware processor configured to: using a security application, select at least one system file and identify at least one attribute of the selected at least one system file, obtain attributes of the selected at least one system file from a repository at which one or more of: system files of an operating system, and attributes of the system files, are stored, compare the attributes of the selected at least one system file obtained from the repository against the identified at least one attribute of the selected at least one system file, when the identified at least one attribute of the selected at least one system file does not match the attributes obtained from the repository, send the selected at least one system file to a remote service for determining whether or not the at least one system file contains malware, and receive a response from the remote service indicating whether or not the selected at least one system file contains malware.

In one exemplary aspect, a non-transitory computer-readable medium is provided storing a set of instructions thereon for identifying system files to be checked for malware using a remote service, wherein the set of instructions comprises instructions for: using a security application, selecting at least one system file and identifying at least one attribute of the selected at least one system file, obtaining attributes of the selected at least one system file from a repository at which one or more of: system files of an operating system, and attributes of the system files, are stored, comparing the attributes of the selected at least one system file obtained from the repository against the identified at least one attribute of the selected at least one system file, when the identified at least one attribute of the selected at least one system file does not match the attributes obtained from the repository, sending the selected at least one system file to a remote service for determining whether or not the at least one system file contains malware, and receiving a response from the remote service indicating whether or not the selected at least one system file contains malware.

In one aspect, the system file is contained in a server on which backups of the system files of the operating system are stored.

In one aspect the at least one system file is selected randomly.

In one aspect, the at least one system file is selected when the system file appeared on a computing device of a user within a pre-determined time interval from a time at which the least one system file is selected.

In one aspect, the at least one system file is selected when the system file has been modified within a pre-determined time interval from a time at which the least one system file is selected.

In one aspect, the identified at least one attribute of the selected at least one system file comprises at least a hash sum of the system file.

In one aspect, the method further comprises: checking, using a local database, the selected at least one system file for malware prior to performing the comparison of the attributes of the selected at least one system file obtained from the repository against the attributes of the identified at least one attribute of the selected at least one system file.

In one aspect, the method of the present disclosure determines whether or not system files contain malware using a remote service, e.g., a cloud service. The method is designed to send the system files to a remote service, a cloud network based service, e.g., antivirus service, for a detailed analysis. The detailed analysis is used to determine whether or not the system file contains malware that may be harmful, e.g., for data security. Thus, the method of the present disclosure improves data security.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an example of a system for identifying system files to be checked for malware using a remote service in accordance with aspect of the present disclosure.

FIG. 2 illustrates an exemplary method for identifying system files to be checked for malware using a remote service in accordance with aspects of the present disclosure.

FIG. 3 presents an example of a general purpose computer system on which aspects of the present disclosure can be implemented.

### DETAILED DESCRIPTION

Exemplary aspects are described herein in the context of a system, method, and a computer program for identifying system files to be checked for malware using a remote service, e.g., a cloud service or a service provided via a remote server. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

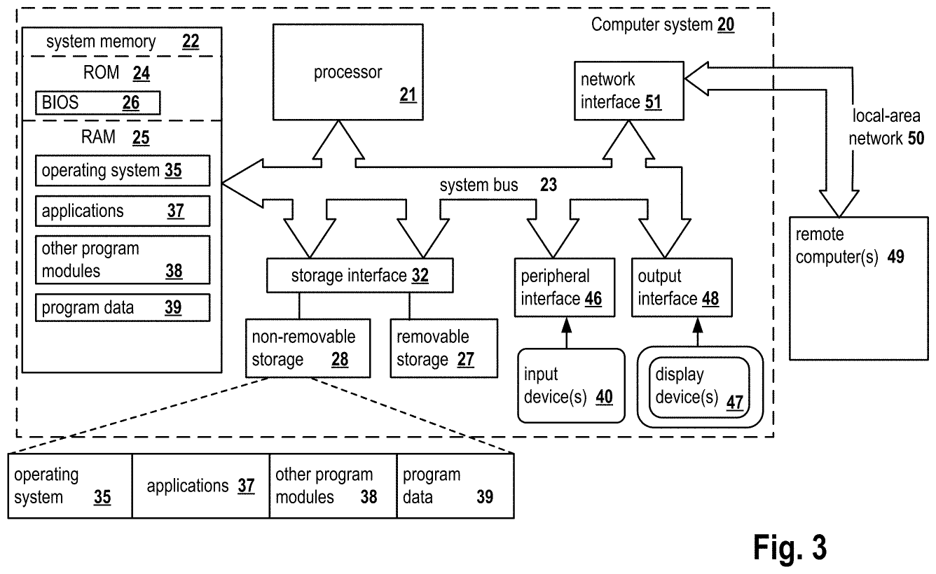

In one aspect, the present disclosure describes a system for identifying system files to be checked for malware using a remote service that is implemented on a computing system (e.g., a server, computer, etc.), that includes real-world devices, systems, components, and groups of components realized with the use of hardware such as integrated microcircuits (application-specific integrated circuits, ASICs) or field-programmable gate arrays (FPGAs) or, for example, in the form of a combination of software and hardware such as a microprocessor system and set of program instructions, and also on neurosynaptic chips. The functionality of such means of the system may be realized solely by hardware, and also in the form of a combination, where some of the functionality of the system means is realized by software, and some by hardware. In certain aspects, some or all of the components, systems, etc., may be executed on the processor of a general-purpose computer (such as the one shown in FIG. 3). Furthermore, the system components may be realized either within a single computing device or spread out among several interconnected computing devices.

In one aspect, the method of the present disclosure uses remote network based technologies, e.g., cloud based technologies, such as Kaspersky Security Network, to determine whether or not a file contains malware. Therefore, the method of the present disclosure is realized on a remote server or in a cloud network—rather than on the computing device of the user. This approach is beneficial in that the algorithm used for determining the harmfulness of files that contain malware can be complex, as there would be more relaxed time requirement for execution of the algorithms. Moreover, the user is not inconvenienced when the harmfulness of the file is being determined. However, sending all system files to the cloud network or remote server is inadvisable, given the data volume and the substantial time it would take to check all of the system files. Even if it is in the cloud space, massive amount of resources would be needed. Therefore, the method of the present disclosure first identifies which files need to be checked. For instance, for the computing device of the user, some system files may be checked using cloud/remote server based technologies while others are checked locally.

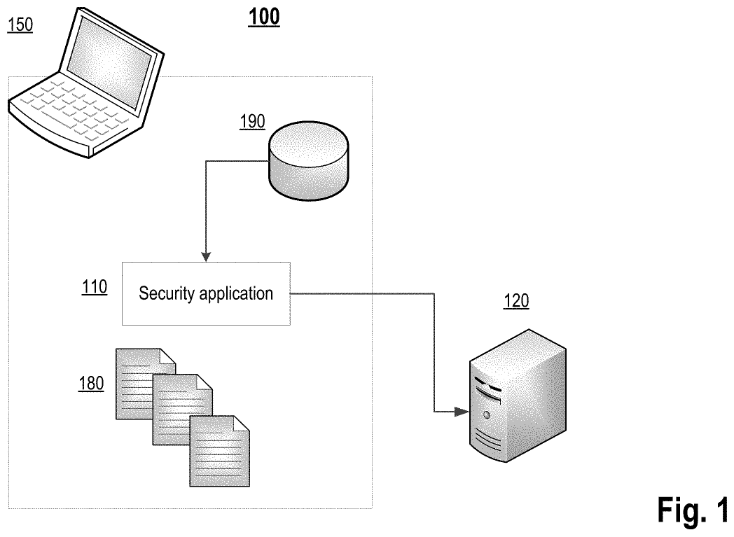

FIG. 1 illustrates an example of a system 100 for identifying system files to be checked for malware using a remote service, e.g., a cloud service, in accordance with aspect of the present disclosure. In one aspect, the system 100 comprises a security application 110 (such as an antivirus application) and a cloud service 120 for identifying system files to be checked for malware using the cloud service.

In one aspect, the security application 110 runs on the computing device 150 of a user. The system files 180 of the computing device 150 may need to be checked to determine whether or not the files contain malware and are harmful. The security application may communicate with the cloud service 120 via any type of network, e.g., the internet, wired/wireless networks, etc. The cloud service 120 may be implemented via any number or network of servers.

The security application 110 selects at least one system file 180 (for example, during a pre-scheduled check of the files 180 for harmfulness).

In one aspect of the present disclosure, the system file 180 comprises any given file about which information is contained in the repository 190 which is used to store backup copies of system files of the operating system. In one aspect, the repository 190 is created by the operating system of the computing device 150 in the process of setting up the operating system on the computing device 150.

In one aspect, the repository 190 is used to store at least the following information about the system file 180 and/or the attributes of the system file 180:
a copy of the system file 180 (e.g., binary data);
a path along which the system file 180 is located;
a date and time at which the system file 180 is added to the repository 190; and
a hash sum of the system file 180.

The operating system (such as those of the Windows family) performs a monitoring of the system files 180. Moreover, in the event that the system file 180 is altered, damaged or missing, the operating system attempts to restore the system files 180 from the repository 190, which is used to store the backup copies of system files 180. However, malicious software are typically designed with mechanisms for altering the system files 180 such that the alterations are not detected by the operating system. Consequently, the operating system may not restore the system files 180 from the repository 190 that contains the backup copies of system files. Moreover, upon restoring a system file 180 by the operating system from the repository 190, the cause of the alteration or damage of the system file 180 is neither identified nor eliminated. For example, suppose a malicious file introduces malicious code into an existing system file 180 (i.e., infects the system file 180). Then, upon launching, the malicious file may perform a monitoring of the accessing of the infected system file 180 and prevent modification of the infected system file (e.g., conceals the infected system file 180, prevents writing to the infected system file, terminates a process attempting to open the system file 180 with writing rights, and so forth). In another example, suppose a malicious file replaces the system file 180 with itself. When executed, the malicious file simulates the operations (repeats the functionality of the original system file 180, striving not to excite the suspicion of the user. In yet another example, suppose a malicious file modifies (alters) a system file 180 so that, when launched, the modified system file 180 downloads a malicious file. In certain instances, the malicious file may also damage the restoration mechanisms for system files—which may include damaging the functionality for restoration of the system file 180 by obtaining the backup copy from the repository 190.

In one aspect, the operating system of the present disclosure includes mechanisms (features) for maintaining a current state of the repository 190 used for storing the backup copies of system files of the operating system. When the system files are updated (for example, a security update or an updated package of the operating system is installed), the repository 190 for storing the backup copies of system files is also updated. In one aspect, the operating system of the present disclosure includes mechanisms for restoring to a predetermines state of the repository 190. For example, the repository 190 may be updated with timestamps, while ensuring the repository 190 itself is restorable from a previous state.

In one aspect, the method of the present disclosure may be used for any type of operating system having a repository, e.g., repository 190 for storing backup copies of the system files 180 and/or attributes of the system files. Some examples of the operating systems include non-specialized operating systems, e.g., Windows, Linux, and the like, and specialized operating systems, e.g., Kaspersky OS.

In one aspect, the security application 110 selects the system files 180 at random.

In one aspect, the method selects system files 180 which have been stored on the computing device 150 of the user within a predetermined time interval from the time of the selection. For example, files that have been stored within a last 24 hours may be selected.

In one aspect, the method of the present disclosure may select system files 180 which have been accessed by the user of the computing device 150 within a predetermined time interval from the time of the selection.

In one aspect, the method selects system files 180 which have been altered (modified) within a predetermine time interval from the time of the selection. For example, the modification or alteration may indicate that a malicious application was executed on the computing device 150 of the user. For instance, the alteration may comprise altering or patching the system file 180.

In one aspect, the security application 110 first performs a local check for determining whether or not the selected system file 180 contains malware and for determining the harmfulness. In one aspect, the local check is based on methods known in the relevant art, e.g., using signature or heuristic analysis, emulation, and the like.

In one aspect, the method of the present disclosure the security application 110, for the selected system files 180, obtains attributes from the repository 190 at which the backup copies of the system files 180 of the operating system are stored. In one aspect, the security application 110 obtains, for the selected system files 180, the attributes from the repository 190 of backup copies of the system files of the operating system, identifies at least one attribute for the selected system files 180 (at least by calculating the hash sum), and compares the identified at least one attribute with the attributes obtained from the repository 190 of backup copies of the system files of the operating system.

For each selected system file 180, in the event that the at least one attribute of the system file 180 (at least the hash sum) do not correspond to the attributes of the system file 180 obtained from the repository 190 of backup copies, the security application 110 sends the system file 180 to a remote service, e.g., a cloud service such as cloud service 120, for determining whether or not the system file 180 includes malware. In other words, it is likely that the system file has been altered, and the security application 110 sends this altered system file 180 to the cloud service 120 for checking to determines whether malware is contained in the system files (such as the Kaspersky Security Network).

Then, in the cloud service 120, the altered system file 180 undergoes a more far-reaching analysis for detecting malwares. In addition, the type of malware may be identified and the harmfulness may be determined. In one aspect, the analysis in the cloud service 120 includes both automated analysis and analysis by an expert in information security. In one aspect, the result of the analysis of the altered system file 180, by the cloud service 120, is provided to the security application 110. For example, the result of the analysis may comprise data that may be used by the security application 110 for subsequent detection of malicious software. For instance, signature or behavioral records may be added to the antivirus databases and used by the security application 110 for detecting malicious software on the computing devices 150 of the users. The computing device 150, having received the updates of the antivirus databases, may prevent infection of other computing devices.

It should be understood that there is a significant difference in time between the detection of a malware in system files (for example, the system file 180 altered by malicious software) by the security application 110 on the computing device, and its detection by analysis in the remote service, e.g., the cloud service.

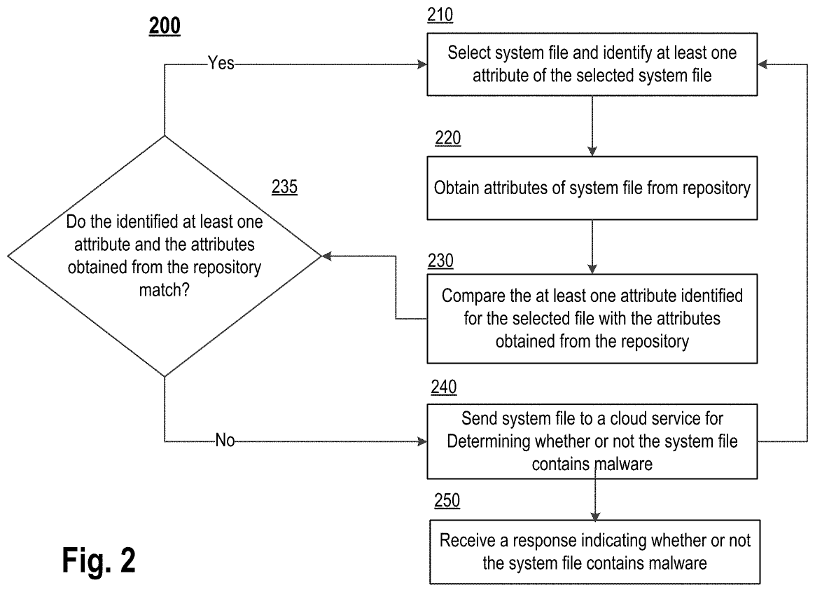

FIG. 2 illustrates an exemplary method 200 for identifying system files to be checked for malware using a remote service, e.g., a cloud service, in accordance with aspects of the present disclosure. The method 200 may be implemented on a computing system that comprises any number of devices, e.g., the system 100 described above.

In step 210, by a security application 110, method 200 selects at least one system file 180 and identifies at least one attribute of the selected at least one system file 180.

In one aspect, the at least one system file 180 is selected, by the security application 110, at random.

In one aspect, the selected at least one system files 180 comprise files that have been stored on the computing device 150 of the user within a predetermined time interval from a time at which the least one system file 180 is selected.

In one aspect, the selected at least one system files 180 comprises files that have been altered (modified) within a predetermined time interval from a time at which the at least one system file 180 is selected. For example, the files that have been recently altered may be selected.

In one aspect, the identified at least one attribute of a selected system file 180 includes at least one of:
a copy of the system file 180 (binary data);
a path along which the system file 180 is situated or located;
a date and time at which the system file 180 is added to a repository 190 used to store backup copies of the system files; and
a hash sum of the system file 180.

In one aspect, method 200 further comprises: by the security application 110, performing a local check to determine whether the selected system file 180 includes malware. For example, signature analysis may be performed by the security application 110 prior to the comparison against attributes obtaining from the repository.

In step 220, by the security application 110, method 200 obtains attributes of the selected at least one system file 180 from a repository 190 at which system files 180 of the operating system and/or attributes of the system files are stored (e.g., backup copies of the system files 180 and/or their attributes may be stored in repository 190).

In step 230, by the security application 110, method 200 compares the identified at least one attribute of the selected at least one system file 180 (i.e., identified in step 210) with the attributes of the selected at least one system file 180 (i.e., obtained in step 220) obtained from the repository 190.

In step 235, by the security application 110, method 200 determines whether or not the identified at least one attribute of the selected at least one system file 180 and the attributes obtained from the repository match. In the event that, the attributes of the selected at least one system file 180 obtained from the repository 190 and the identified at least one attribute of the selected at least one system file 180 do not match, method 200 proceeds to step 240. Otherwise, the method returns to step 210.

In step 240, by the security application 110, method 200 sends the selected at least one system file 180 to a remote service, e.g., a cloud service 120, for determining whether or not the at least one system file 180 contains malware.

In step 250, method 200 receives a response from the remote service indicating whether or not the selected at least one system file contains malware. For example, the remote service (cloud service or remote server) performs an in-depth analysis and sends a response to the security of application 110 indicating whether or not the analysis identified any malware. The response may further include an indication as to harmfulness of the malware.

In one aspect, method 200 further comprises: receiving, by the security application 110, data for subsequent detection of malicious software, the data including at least newly identified malware and analysis of the harmfulness of the malware. For example, the result of the analysis (the analysis by the cloud or remote server) of the selected at least one system file 180 that has been altered will be added to the antivirus databases and used by the security application 110 for subsequently detecting malicious software on the computing devices of the user. The data sent to the computing device of the user may include signatures or behavioral records of malicious files. Then, the security application 110, having received data for updating the antivirus databases, is better equipped to provide protection to data of the user.

In one aspect, method 200 returns to step 210 to continue selecting more system files to be checked for malware using a remote service.

FIG. 3 is a block diagram illustrating a computer system 20 on which aspects of systems and methods for identifying system files to be checked for malware using a remote service may be implemented in accordance with exemplary aspects. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 3, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for identifying system files to be checked for malware using a remote service, the method comprising:
selecting, using a security application, at least one system file and identifying at least one attribute of the selected at least one system file;
obtaining, using the security application, attributes of the selected at least one system file from a repository at which one or more of: system files of an operating system, and attributes of the system files, are stored;
comparing, using the security application, the attributes of the selected at least one system file obtained from the repository against the identified at least one attribute of the selected at least one system file;
when the identified at least one attribute of the selected at least one system file does not match the attributes obtained from the repository, sending, by the security application, the selected at least one system file to a remote service for determining whether or not the at least one system file contains malware; and
receiving a response from the remote service indicating whether or not the selected at least one system file contains malware.

2. The method of claim 1, wherein the system file is contained in a server on which backups of the system files of the operating system are stored.

3. The method of claim 1, wherein the at least one system file is selected randomly.

4. The method of claim 1, wherein the at least one system file is selected when the system file appeared on a computing device of a user within a pre-determined time interval from a time at which the least one system file is selected.

5. The method of claim 1, wherein the at least one system file is selected when the system file has been modified within a pre-determined time interval from a time at which the least one system file is selected.

6. The method of claim 1, wherein the identified at least one attribute of the selected at least one system file comprises at least a hash sum of the system file.

7. The method of claim 1, further comprising:
checking, using a local database, the selected at least one system file for malware prior to performing the comparison of the attributes of the selected at least one system file obtained from the repository against the attributes of the identified at least one attribute of the selected at least one system file.

8. A system for identifying system files to be checked for malware using a remote service, comprising:
at least one processor configured to:
select, using a security application, at least one system file and identify at least one attribute of the selected at least one system file;
obtain, using the security application, attributes of the selected at least one system file from a repository at which one or more of: system files of an operating system, and attributes of the system files, are stored;
compare, using the security application, the attributes of the selected at least one system file obtained from the repository against the identified at least one attribute of the selected at least one system file;
when the identified at least one attribute of the selected at least one system file does not match the attributes obtained from the repository, send, by the security application, the selected at least one system file to a remote service for determining whether or not the at least one system file contains malware; and
receive a response from the remote service indicating whether or not the selected at least one system file contains malware.

9. The system of claim 8, wherein the system file is contained in a server on which backups of the system files of the operating system are stored.

10. The system of claim 8, wherein the at least one system file is selected randomly.

11. The system of claim 8, wherein the at least one system file is selected when the system file appeared on a computing device of a user within a pre-determined time interval from a time at which the least one system file is selected.

12. The system of claim 8, wherein the at least one system file is selected when the system file has been modified within a pre-determined time interval from a time at which the least one system file is selected.

13. The system of claim 8, wherein the identified at least one attribute of the selected at least one system file comprises at least a hash sum of the system file.

14. The system of claim 8, the processor further configured to:
check, using a local database, the selected at least one system file for malware prior to performing the comparison of the attributes of the selected at least one system file obtained from the repository against the attributes of the identified at least one attribute of the selected at least one system file.

15. A non-transitory computer readable medium storing thereon computer executable instructions for identifying system files to be checked for malware using a remote service, including instructions for:
selecting, using a security application, at least one system file and identifying at least one attribute of the selected at least one system file;
obtaining, using the security application, attributes of the selected at least one system file from a repository at which one or more of: system files of an operating system, and attributes of the system files, are stored;
comparing, using the security application, the attributes of the selected at least one system file obtained from the repository against the identified at least one attribute of the selected at least one system file;
when the identified at least one attribute of the selected at least one system file does not match the attributes obtained from the repository, sending, by the security application, the selected at least one system file to a remote service for determining whether or not the at least one system file contains malware; and
receiving a response from the remote service indicating whether or not the selected at least one system file contains malware.

16. The non-transitory computer readable medium of claim 15, wherein the system file is contained in a server on which backups of the system files of the operating system are stored.

17. The non-transitory computer readable medium of claim 15, wherein the at least one system file is selected randomly.

18. The non-transitory computer readable medium of claim 15, wherein the at least one system file is selected when the system file appeared on a computing device of a user within a pre-determined time interval from a time at which the least one system file is selected.

19. The non-transitory computer readable medium of claim 15, wherein the at least one system file is selected when the system file has been modified within a pre-determined time interval from a time at which the least one system file is selected.

20. The non-transitory computer readable medium of claim 15, wherein the identified at least one attribute of the selected at least one system file comprises at least a hash sum of the system file.

21. The non-transitory computer readable medium of claim 15, wherein the instructions further comprise instructions for:
checking, using a local database, the selected at least one system file for malware prior to performing the comparison of the attributes of the selected at least one system file obtained from the repository against the attributes of the identified at least one attribute of the selected at least one system file.
